(19) United States
(12) Patent Application Publication
(10) Pub. No.: US 2005/0131717 A1
(43) Pub. Date: Jun. 16, 2005

(54) Pre-sales technical consulting

(76) Inventors: Christopher John Peltz, Windsor, CO (US); Laura Ann Smyrl, Fort Collins, CO (US); John Justin Murray, San Francisco, CA (US); Mark Stephen Secrist, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/736,247

(22) Filed: Dec. 15, 2003

(51) Int. Cl. G06F 17/60

(52) U.S. Cl. 705/1

(57) ABSTRACT

Systems, methodologies, media, and other embodiments associated with pre-sales technical consulting are described. One exemplary system embodiment includes a tracking data store configured to store data concerning an ATC team pre-sales technical consulting engagement, a decision guiding logic configured to facilitate making decisions during the pre-sales technical consulting engagement and a user interface logic configured to facilitate displaying data stored in the tracking data store and decision guiding data provided by the decision guiding logic.

### BACKGROUND

Organizations that sell high-technology items like software, computers, development services, integrated circuits, distributed development tools, technical support, Web services tools, and so on, acquire a certain understanding of the items they are selling. For example, a sales person may know how many millions of instructions per second a processor can perform, how much the processor costs, and the operating systems that currently support the processor. Thus, a “customer-facing” portion of an organization, like the sales force, may be product-centric or product-focused.

In some pre-sales situations, (e.g., customer considering hiring organization for services, customer considering purchasing hardware, software from organization) these “customer-facing” members of an organization may benefit from having other customer-facing members of their organization, (e.g., “technical consultants” who have a greater technical understanding of a certain high-technology item), available to interface with the customer. These technical consultants may have studied a certain item and thus gained a greater understanding of the high-technology item features, capabilities, benefits, comparison points with competing items, and so on. For example, a technical consultant may know with which computing platforms a processor works, may be able to compare and contrast a processor with other processors, may know heat dissipation requirements of a processor, may know processor power supply requirements, and so on. Thus, the technical consultant may be less product-centric than the sales force, but may still not have the in depth understanding of the technology underpinnings of a product.

Thus, even these technical consultants may benefit from having access to advanced technical consultants with an expert level understanding of a high-technology item and who can develop solutions to issues associated with an item. Solutions may include, for example, integrating multiple products and/or technologies together to facilitate demonstrating things like the benefits of open standards, product integration, Web services, and so on. The advanced technical consultants may have the in-depth understanding of the technology behind such a solution, which can be useful in development and/or applying the technology in a product or product suite. However, such advanced technical consultants are typically not part of the customer-facing portion of an organization. Thus, in a pre-sales environment, when being able to address an issue with a high-technology item may determine a business outcome, appropriate advanced technical personnel may not be locatable, engageable, amenable, and/or available to support the customer-facing portion of an organization.

### BRIEF DESCRIPTION OF THE DRAWINGS

The accompanying drawings, which are incorporated in and constitute a part of the specification, illustrate various example systems, methods, and so on that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example pre-sales technical consulting method.

FIG. 2 illustrates a portion of an example pre-sales technical consulting method.

FIG. 3 illustrates another example portion of a pre-sales technical consulting method.

FIG. 4 illustrates an example pre-sales technical consulting method.

FIG. 5 illustrates an example system for supporting a pre-sales technical consulting engagement.

FIG. 6 illustrates an example computing environment in which example systems and methods illustrated herein can operate.

### DETAILED DESCRIPTION

An advanced technical consulting (ATC) team generally includes a small number (e.g., less than ten), of focused (e.g., project/issue oriented), highly skilled (e.g., technical degree(s)), experienced people. An example ATC team may include people skilled in technologies like, Web services, mobile development, Java 2 Platform Enterprise Edition (J2EE) tools, J2EE solutions, J2EE architectures, extensible markup language (XML), Java, performance tuning, Java strategy, Java products, Java virtual machine (JVM) issues, integrated circuit design, hardware/software integration, object-oriented design and programming, and so on. An ATC team may be a member of a larger organization like an organization that provides hardware, software, developer resources, services, and so on. An ATC team may find itself positioned as a bridge between various other portions of an organization. By way of illustration, an ATC team may span the knowledge gap between a research and development (R&D) portion of an organization and a sales portion of an organization. Similarly, an ATC team may connect standards groups and product development groups. Thus, an ATC team may be well positioned to see much of what happens in and/or to an organization and thus to disseminate information through the organization about projects, products, developments, standards, client issues and so on. For example, an ATC team may bridge between a lab and a customer by taking product information from a lab, applying that technology to a customer solution, and then facilitating a customer understanding the workings and benefits of that technology. Similarly, the ATC team may bridge back from the customer to the lab by providing customer feedback concerning a technology or solution to the lab.

This application describes example methods and systems related to an ATC team that supports a customer-facing portion of an organization by engaging in pre-sales technical consulting. Example systems and methods may facilitate servicing a customer need while providing feedback to an organization with which the ATC team is associated. The feedback may concern, for example, problems discovered, lessons learned, solutions generated, and so on, before and/or during a pre-sales technical consulting engagement. The example systems and methods may also facilitate determining when an ATC team should engage in a project.

The example systems and methods may facilitate identifying when a customer needs help with application development in a pre-sales situation that could be profitable for the parent organization of an ATC team. Similarly, the example systems and methods may facilitate determining who “owns” an engagement and thus who is responsible for issues like customer satisfaction, organizational learning associated with the engagement, and so on. In one example, methods may be monitored by an engagement tracking system. In another example, methods may be supported by a decision guiding logic that can be configured to facilitate guiding decisions during the engagement. Information from the tracking system and/or decision guiding logic may be available to users via systems including, but not limited to, a user interface, a web-based application, a client-server system, and the like. The information may be available to the ATC team members and/or to people outside the ATC team (e.g., R&D group, sales group, management group).

The following includes definitions of selected terms employed herein. The definitions include various examples and/or forms of components that fall within the scope of a term and that may be used for implementation. The examples are not intended to be limiting. Both singular and plural forms of terms may be within the definitions.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communication flow, and/or logical communication flow may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

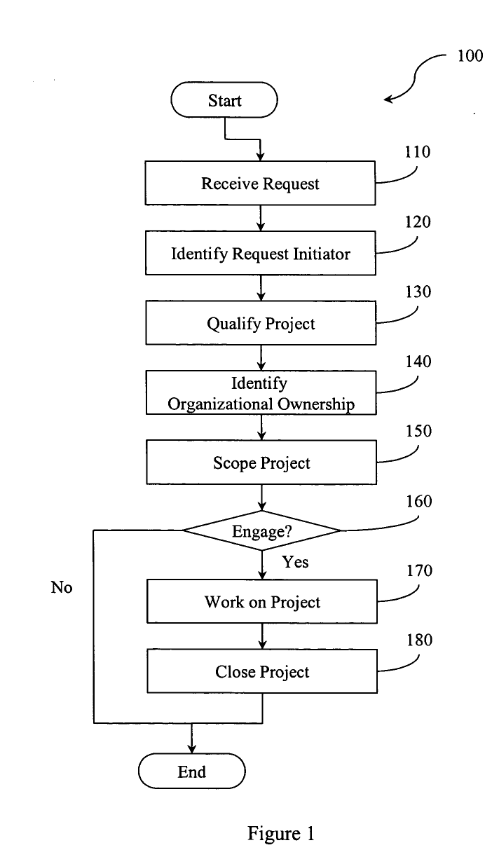

Example methods may be better appreciated with reference to the flow diagrams of FIGS. 1 through 4. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks.

In the flow diagrams, blocks denote “processing blocks” that may be implemented with logic. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on are not shown. It will be further appreciated that electronic and software applications may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented and/or artificial intelligence techniques.

FIG. 1 illustrates an example pre-sales technical consulting method 100 associated with an advanced technical consulting (ATC) team that may support a customer-facing portion of an organization. The organization may be, for example, a company, or a division of a company. The method 100 may include, at 110, receiving a request to engage in a technical consulting project. The request may be received, for example, by a voice mail, a phone call, an email, a written request, an in-person communication, a communication during a customer engagement, a communication during a customer opportunity, and so on. The request may be generated by various entities (e.g., customer, sales person, technical consultant, ATC team member), and thus may need to be examined.

Therefore, the method 100 may also include, at 120, identifying an initiator of the request. Identifying the initiator may facilitate determining whether to engage in a project by providing information about the importance, value, experience, expertise, and so on of the initiator and thus how seriously to take the request. In one example, identifying the initiator may include identifying whether the initiator is a member of the organization. If the initiator is a member of the organization (e.g., sales person, technical consultant), then a first set of tasks may be assigned to the initiator (e.g., collecting customer data) and a second set of tasks may be assigned to the ATC team (e.g., understanding initiator's role in the organization). If the initiator is not a member of the organization, then the ATC team may engage in a different set of tasks that may include establishing a relationship between the initiator and a member of the customer-facing part of the organization. Establishing a relationship between the initiator and a member of the organization can facilitate having tasks handled by an appropriate member of the organization. For example, establishing a relationship with a member of the customer-facing portion of the organization can facilitate providing a customer/initiator with a point of contact trained to deal with customers. Thus it is to be appreciated that the ATC team and/or an ATC team member will collaborate on some level with the organizational owner (e.g., sales representative, relationship manager) who has “ownership” of the customer.

In another example, identifying the initiator of the request may include identifying whether the initiator has an established contact with the organization. Additionally, identifying the request initiator may include gathering an initiator relationship data concerning issues like, an initiator relationship to a customer, an initiator relationship to the ATC team, an initiator relationship to the organization, and so on. Understanding the various relationships may facilitate, for example, prioritizing projects.

The method 100 may also include, at 130, qualifying the technical consulting project. Qualifying the project may facilitate determining whether to scope the project and/or perform other subsequent actions in method 100. In one example, qualifying the technical consulting project may include determining issues like, whether the technical consulting project is a pre-sales project, whether a customer has a support contract with the organization, whether the ATC team is interested in solving a problem associated with the technical consulting project, whether the ATC team is qualified to solve the problem associated with the technical consulting project, whether the ATC team has a resource available to engage in the technical consulting project, whether the technical consulting project is aligned with a goal of the ATC team, and so on. For example, a project that involves uninteresting questions whose resolutions are unrelated to an ATC team goal may not qualify for ATC team engagement. In such a situation, the project may be assigned to another part of the organization better suited to engage in the project. By way of illustration, if the ATC team is part of a Web services providing organization and the project concerns a batch processing problem on a legacy mainframe computer, the project may not qualify for ATC team engagement because legacy mainframe issues are not questions that are interesting to the ATC team. In this case, the ATC team might assist in re-assigning the project to a division in the organization that supports legacy mainframe applications.

The method 100 may also include, at 140, identifying an organizational ownership of the technical consulting project. This facilitates determining who is ultimately responsible for a relationship with a customer associated with the project. Identifying the organizational ownership of the technical consulting project may include, for example, acquiring a customer data that facilitates characterizing a customer, acquiring a project data that facilitates characterizing the technical consulting project, and analyzing the customer data, the project data, and the request to engage in the technical consulting project to determine who is responsible for the customer. Identifying the organizational ownership may also include examining relationships between entities like the initiator, the customer, the ATC team, and the organization. The customer data that is examined can include, for example, a name data, an accounts receivable data, a bill paying history data, a location data, and an expertise data. Similarly, the project data that is examined can include, for example, a name data, a time estimate data, a cost estimate data, an account number, a technical consultant data, and a projected return on investment data. Understanding organizational ownership can facilitate, for example, determining an appropriate organizational level on which decisions concerning the project should be made. For example, a ten thousand dollar local account owned by a local sales representative may receive a first level of ATC team attention based on its organizational ownership while a fifty million dollar national account owned by the senior vice president of sales may receive a second level of ATC team attention based on its organizational ownership.

The method 100 may also include, at 150, scoping the technical consulting project. In one example, scoping the technical consulting project may include acquiring a scope data that facilitates understanding what it will take to do the project. The scope data may include, for example, data concerning a customer problem, a customer suggestion, a customer need, a business problem to be solved for a customer, a customer history with the organization, a customer history with the ATC team, a revenue associated with the technical consulting project, a cost associated with the technical consulting project, a return on investment associated with the technical consulting project, a customer expertise level, a customer architecture, a measure of success for the technical consulting project, and an expected outcome of the technical consulting project. Thus, in addition to identifying technical tasks required to do the project (e.g., implementing a Web service, integrating hardware and software, designing a new web interface), scoping the project may include examining the risks and rewards associated with engaging in the project.

The method 100 may also include, at 160, determining whether to engage in the technical consulting project. Determining whether to engage in the technical consulting project may include determining issues like, whether the technical consulting project is a pre-sales technical consulting activity, whether the technical consulting project is appropriate for the ATC team, whether the ATC team is skilled in the area, whether the technical consulting project will result in a positive return on investment for the organization, and so on. In one example, determining whether to engage in the technical consulting project may also include analyzing the scope data. The decision concerning whether to engage the ATC team may be made by, for example, the ATC team, a member of the ATC team, a logic programmed to analyze engagement situations, a member of the customer-facing part of the organization, combinations thereof, and the like.

If the determination at 160 is Yes, that the ATC team should engage in the technical consulting project, then the method 100 may continue at 170 and include selectively working on the technical consulting project. Selectively working on the technical consulting project may include, for example, identifying a criteria for determining a success of the technical consulting project and developing a solution that satisfies the criteria. The solution may be based, for example, on data like the customer data, the project data, and the scope data. Working on the technical consulting project may also include communicating the solution to the customer and/or customer-facing portion of the organization and selectively providing a project tracking data to a project tracking data store. The project tracking data may facilitate characterizing a project (e.g., describing a project, identifying a project, following a project). While working on the project, the ATC team will, in one example, communicate with people like the customer, the initiator, the organizational owner, and so on. The communications may be, for example, verbal, written, email, in person meetings, net-meetings, and so on. Thus, part of working on the project may include ensuring that expenses generated during the project (e.g., travel expenses, communication expenses) are accounted for by the customer-facing organization, the R&D organization, and/or the customer.

The method 100 may also include, at 180, closing the technical consulting project. Closing the technical consulting project may include, for example, acquiring an agreement from the customer, the initiator, and/or the organizational owner that the technical consulting project is complete. Additionally, closing the technical consulting project may include selectively making available a project experience data derived from the project tracking data. The project experience data may include, for example, a best practices data that identifies a best business practice associated with the technical consulting project, a software error data that identifies a software error associated with the technical consulting project, a hardware error data that identifies a hardware error associated with the technical consulting project, an integration error data that identifies an integration error associated with the technical consulting project, a customer experience data that characterizes the customer as experienced during the technical consulting project, and so on. Thus, a best practices data may include, for example, a technical presentation, a technical article, a whitepaper, a trip report, a webinar, and so on. Additionally, the project experience data may include information concerning how the various errors (e.g., software, hardware, integration) were resolved.

While FIG. 1 illustrates various actions occurring in serial, it is to be appreciated that various actions illustrated in FIG. 1 could occur substantially in parallel. By way of illustration, a first process could receive requests and identify requestors, a second process could qualify projects and identify organizational ownership, and a third process could scope the project and determine whether to engage in the project. While three processes are described, it is to be appreciated that a greater and/or lesser number of processes could be employed and that lightweight processes, regular processes, threads, and other approaches could be employed.

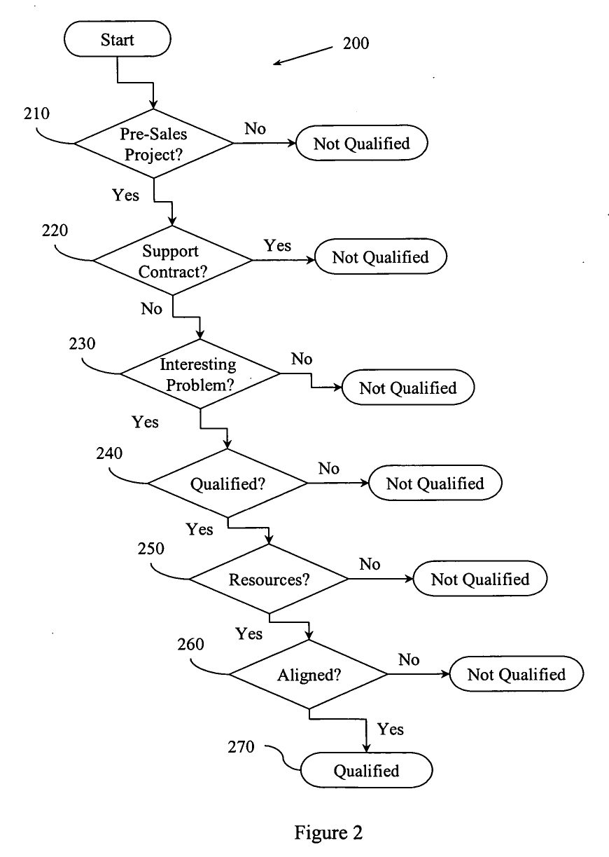

FIG. 2 illustrates a portion 200 of an example pre-sales technical consulting method. The portion 200 concerns qualifying a technical project. Thus, the portion 200 may include, at 210, determining whether the project is a pre-sales project. If it is not a pre-sales project, then the project may not qualify for engagement by the ATC team. For example, if an existing customer initiates a request for ATC team engagement concerning an already purchased product, the request, not being a pre-sales situation, may be more appropriate for a customer support portion of the organization rather than the pre-sales ATC team. The portion 200 may also include, at 220, determining whether a customer for which an engagement request has been made has a service contract with the organization. If the customer does have a service contract, then in one example the project may not qualify for engagement by the ATC team. By way of illustration, if a customer is already paying for a service contract for technical support, or if the customer is in a “warranty period” that includes technical support, then the request may be more appropriate for a customer support portion of the organization.

The portion 200 may also include, at 230, determining whether the project includes an interesting problem. An “interesting problem” may be, for example, a problem associated with an issue not previously encountered and/or resolved by the organization, an issue associated with a flagship item, an issue related to a mission critical item, an issue associated with a recently released item, and so on. A “flagship” item may be, for example, a product the organization has identified itself with and upon which the organization is depending for prestige, revenue, profit, and so on. Thus, an “interesting problem” may be, for example, a problem relating to issues like, integrating various software components, integrating various hardware components, integrating software and hardware components, providing various Web services, utilizing various development tools, and so on. If the project does not contain an interesting problem, then the project may not qualify for engagement by the ATC team.

The portion 200 may also include, at 240, determining whether the ATC team is qualified to solve the problem. If the ATC team is not qualified, then the project may not be suitable for engagement by the ATC team. For example, if solving the problem requires radio-frequency analysis and the ATC has neither radio-frequency engineers, equipment, skills, nor experience, then the ATC team may not be qualified to solve the problem. Similarly, the portion 200 may also include, at 250, determining whether the ATC team has a resource(s) for solving the problem. For example, if solving the problem requires a Java expert currently available and the ATC team does not have a Java expert, then the project may not qualify for engagement by the ATC team. Likewise, the portion 200 may also include, at 260, determining whether the problem to be solved is aligned with a goal for the ATC team and/or the organization. For example, the ATC team may be tasked with goals like identifying issues associated with integrating a new processor into existing systems. If solving the problem would not further this goal, then the project may not be aligned with the goals of the ATC team and thus the project may not qualify for engagement by the ATC team.

While FIG. 2 illustrates various actions occurring in serial, it is to be appreciated that various actions illustrated in FIG. 2 could occur substantially in parallel. By way of illustration, a first process could facilitate determining whether the project is a pre-sales project and whether a customer has a service contract. Similarly, a second process could facilitate determining whether the project includes an interesting problem for which the ATC team has resources and qualifications, while a third process could facilitate determining whether the project is aligned with a goal(s) of the ATC team. While three processes are described, it is to be appreciated that a greater and/or lesser number of processes could be employed and that lightweight processes, regular processes, threads, and other approaches could be employed. Furthermore, steps in a decision process for qualifying a project may be logically combined into, for example, logical AND, logical OR, logical XOR relationships and the like.

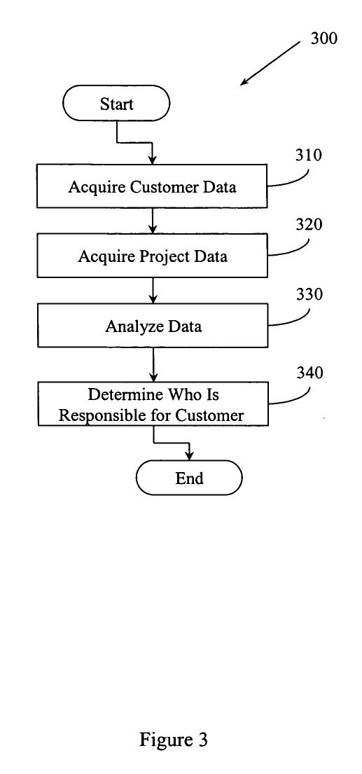

FIG. 3 illustrates an example portion 300 of a pre-sales technical consulting method. The portion 300 concerns identifying the organizational ownership of the technical consulting project. As described above, identifying an organizational ownership can facilitate, for example, determining a level of ATC team interest in a project. Identifying the organizational ownership of the project may include, at 310, acquiring a customer data that facilitates characterizing a customer. Characterizing a customer can include describing qualities, peculiarities, and/or identifying attributes of a customer. Thus, more generally, characterizing, as used herein, refers to describing qualities, peculiarities, and/or identifying attributes of an entity. The qualities, peculiarities, and/or identifying attributes can facilitate making decisions about the entity. For example, the customer data that facilitates characterizing a customer may include, a name data, an accounts receivable data, a bill paying history data, a location data, and an expertise data. The accounts receivable data, when analyzed in light of the bill paying history data may facilitate determining whether the ATC team will engage in a project for a customer.

The portion 300 may also include, at 320, acquiring a project data that facilitates characterizing the technical consulting project. Characterizing the project may facilitate making decisions about the project like whether to engage in the project, whether the ATC team is qualified to work on a project, and so on. Thus, the project data may include a name data, a time estimate data, a cost estimate data, an account number, a technical consultant data, a projected return on investment data, and the like. The cost estimate data, when analyzed in conjunction with the project return on investment data may facilitate determining whether the ATC team will engage in a project.

In one example the portion 300 may identify the organizational ownership (e.g., determine who is responsible for a customer) at 340 after analyzing, at 330, the customer data and the project data. Additionally, and/or alternatively, the portion 300 may identify the organizational ownership at 340 after analyzing the customer data, the project data, the request to engage in the technical consulting project, and relationships between entities like the initiator, the customer, the ATC team, and the organization.

While FIG. 3 illustrates various actions occurring in serial, it is to be appreciated that various actions illustrated in FIG. 3 could occur substantially in parallel. By way of illustration, a first process could periodically and/or substantially constantly acquire customer data. The process may be performed by the ATC team, the customer-facing portion of the organization, and so on. Furthermore, the process could be a partially manual process that includes humans in the organization interfacing with humans in a customer organization and storing data associated with the customer organization. Additionally and/or alternatively the process could be a computerized process performed, for example, by an Internet monitoring application that tracks customer interactions with the organization's computerized processes. A second process could periodically and/or substantially constantly acquire a project data, while a third process could periodically and/or substantially constantly analyze the customer data and the project data. While three processes are described, it is to be appreciated that a greater and/or lesser number of processes could be employed and that lightweight processes, regular processes, threads, and other approaches could be employed.

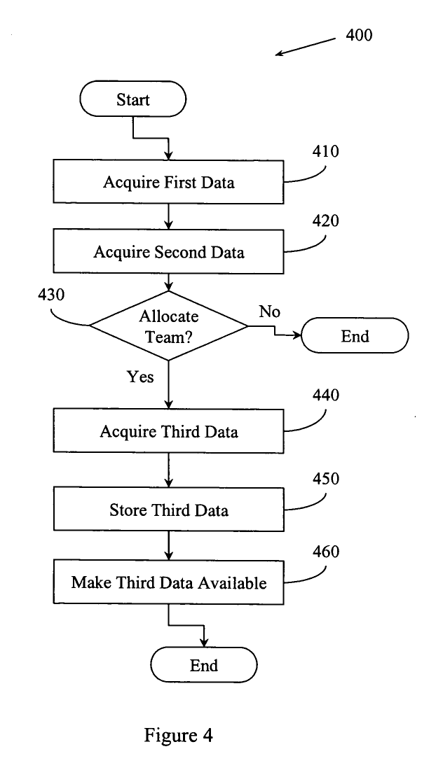

FIG. 4 illustrates an example pre-sales technical consulting method 400. The method 400 may include, at 410, acquiring a first data that facilitates characterizing an ATC team. Characterizing the ATC team may include gathering information about the team's skills, interests, goals, resources, availability, and so on. The characterizing information may facilitate determining whether the ATC team should be allocated to a project. Thus, the first data may include ATC membership information, ATC skill set information, ATC goal information, ATC availability information, and the like.

The method 400 may also include, at 420, acquiring a second data that facilitates characterizing a pre-sales technical consulting project. Characterizing a pre-sales technical consulting project generally concerns acquiring and analyzing data about what will be involved to perform a project. Thus, the second data may include, for example, information concerning a project scope, information concerning tasks to be completed in a project, a project return on investment, a project deadline, organizational ownership of a project, relationship data concerning people for whom the project will be performed and people performing the project, and the like. Thus, actions undertaken at 410 and 420 facilitate learning about an ATC team and an engagement for which the ATC team is being considered. The first and second set of data can be analyzed to determine whether the ATC team should engage in the project. While acquiring the first data 410 and acquiring the second data 420 are illustrated as separate actions, it is to be appreciated that the first and second data may be acquired substantially simultaneously by one or more processes.

The method 400 may also include, at 430, determining whether to allocate the ATC team to the pre-sales technical consulting project based, at least in part, on the first data, the second data, and a relationship(s) between the two. For example, if the first data indicates that an ATC team has a first set of skills and a first availability while the second data indicates that the project will require a second set of skills and a deadline that does not mesh with the first availability, then the team may not be allocated. But, if analyzing the first data and the second data indicates an acceptable fit between the project and the ATC team skills, availability, interest, goals, resources, and so on, then the ATC team may be allocated to the project. The comparison between elements of the first data and elements of the second data may be manual, partially manual, partially automated, and fully automated, for example. By way of illustration, a computer program may analyze elements of the first data and the second data and determine that the capabilities in the first data do not meet the requirements in the second data and thus recommend that the engagement not be accepted.

If the determination at 430 is Yes, that the advanced technical consulting team is to be allocated to the pre-sales technical consulting project, then the method 400 may continue at 440 by selectively acquiring, during the project, a third data that facilitates characterizing the pre-sales technical consulting project. The third data may include, for example, information about errors encountered during the project and how the errors were resolved. By way of illustration, the project may include making two different Web services communicate. However, the two Web services may not initially communicate as desired. Thus, one or both of the Web services may need to be reprogrammed to achieve the desired communication. The third data may, therefore, include information about the two Web services, the fact that they did not initially communicate as desired, and what actions were undertaken to resolve the communication error. This is an example of the type of information that the ATC team may be well positioned to distribute throughout the organization. Distributing the information may, for example, lead an R&D portion of the organization to research one or both of the Web services, cause a customer-facing portion of the organization to not hold out that the two Web services integrate seamlessly, to prompt a development portion of the organization to seek a different combination of Web services, and so on. Furthermore, this investigation could lead to product development advances, feature enhancements, bug fixes and so on within the R&D organization that facilitate reducing interoperability issues between Web services and the like.

The method 400 may also include, at 450, selectively storing one or more portions of the third data in, for example, a data store. By way of illustration, as data is gathered during the project, the ATC team may store selected portions of the gathered data in a database that can be queried to retrieve project information. For example, if the ATC team encounters a problem integrating a piece of software and a piece of hardware, then the ATC team may place information about the integration problem, and its solution, in the data store. The data store may be, for example, a password protected database. The ATC team may determine that certain information in the data store is valuable to other members of the organization. Thus, the method 400 may include, at 460, selectively making the third data available outside the advanced technical consulting team. In the password protected database example, making the third data available may include providing passwords to the protected database. While a password protected database is described, it is to be appreciated that other methods for storing and distributing data like the third data can be employed. For example, a weblog (“blog”), a push service, a list service (listserv), a web page, and other items may be established for distributing the information. Similarly, a paper, technical whitepaper, article, technical presentation, webinar, frequently asked question (FAQ) Web page, trip report, and so on may be produced concerning the problem and its resolution.

In one example, data structures may be constructed that facilitate storing data on a computer-readable medium and/or in a data store. Thus, in one example, a computer-readable medium may store a data structure that includes a first field for data associated with an ATC team pre-sales technical consulting engagement request, a second field for data associated with an ATC team pre-sales technical consulting engagement requester, a third field for data associated with pre-sales technical consulting engagement parameters, and a fourth field for data gathered during the pre-sales technical consulting engagement. With this “raw” data available, the data structure may also include a fifth field for storing “processed data” like a distribution data that is derived from data located in one or more of the first through fourth fields. While five fields are described, it is to be appreciated that a greater and/or lesser number of fields could be employed. For example, a tree structure may be provided where the tree branches and nodes are constructed during a project based on the pre-project data (e.g., request, initiator, scope, ownership) and data gathered during the project (e.g., software/hardware/integration errors and solutions). Then, people interested in tracking the project can traverse the tree to view data, actions, and decisions associated with the project. Once again, while a five field data structure and a tree data structure are described, it is to be appreciated that other data structures can store information associated with a pre-sales technical consulting project.

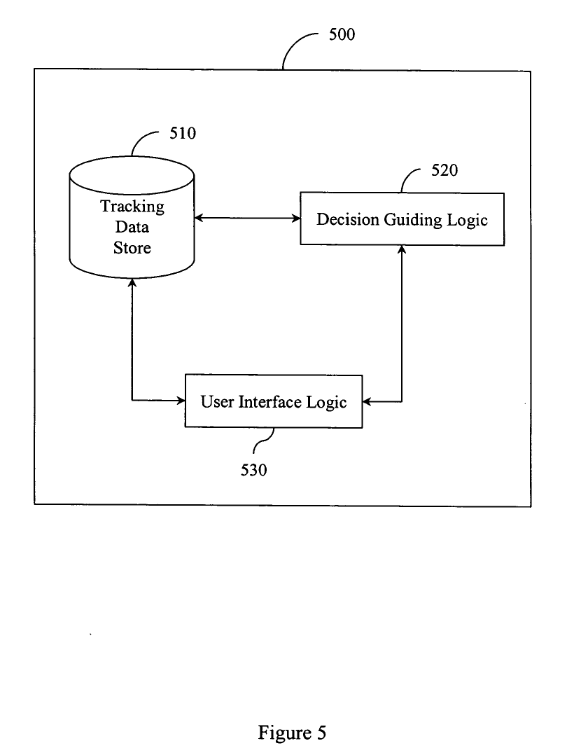

FIG. 5 illustrates an example system 500 for supporting a pre-sales technical consulting engagement. The system 500 may include, a tracking data store 510 configured to store data concerning an ATC team pre-sales technical consulting engagement. The tracking data store 510 may be, for example, an on-line database that is initialized with pre-project data (e.g., customer data, project data, ownership data) and that receives periodic updates about project-in-progress data. For example, the data store 510 may receive information about problems encountered during a project, solutions to those problems, and so on. Thus, the tracking data store 510 may store, for example, an engagement data that facilitates characterizing the consulting engagement, a customer data that facilitates characterizing a customer, an ATC team data that facilitates characterizing the ATC team, a best practice data that facilitates characterizing a best practice associated with the consulting engagement, a software error data that facilitates characterizing a software error associated with the consulting engagement, a hardware error data that facilitates characterizing a hardware error associated with the consulting engagement, an integration error data that facilitates characterizing an integration error observed during the consulting engagement, and resolution data that describes how various errors (e.g., hardware, software, integration) were resolved and/or code fragments (e.g., bug fixes) associated with resolving the error.

The system 500 may also include a decision guiding logic 520 operably connected to the tracking data store 510. The decision guiding logic 520 may be configured to facilitate guiding decisions before and/or during a pre-sales technical consulting engagement. The decision guiding logic 520 may be embodied, for example, as software, hardware, and so on. The decisions considered by the decision guiding logic 520 may depend, at least in part, on data stored in the tracking data store 510. For example, the decision guiding logic 520 may be configured to facilitate determining whether to accept a consulting engagement. Thus, the decision guiding logic 520 may access the tracking data store 510 to locate, compare, and/or analyze data like a project success criteria and an ATC team goal. Then, based on applying heuristics, artificial intelligence, rules, decision making logic, and so on, the decision guiding logic 520 may produce a recommendation concerning whether to accept the engagement. For example, the tracking data store 510 may store information about an ATC team skill set and skills required for a potential consulting engagement. The decision guiding logic 520 may access the ATC team skill set data and the project skill set data stored in the tracking data store 510, process the data, and recommend whether to accept the engagement. Therefore, the decision guiding logic 520 and/or the tracking data store 510 can facilitate collecting and/or analyzing information about a customer opportunity and determining whether to accept the engagement. Furthermore, the decision guiding logic 520 and/or the tracking data store 510 can facilitate collecting ongoing project information that can be employed, for example, in real-time adaptations to project plans and so on.

Thus, the system 500 may also include a user interface logic 530 operably connected to the tracking data store 510 and the decision guiding logic 520. The user interface logic 530 may be configured to display items like data items stored in the tracking data store 510, decision guiding data provided by the decision guiding logic 520, recommendations produced by the decision guiding logic 520, and the like. By way of illustration, the decision guiding logic 520 may acquire various pieces of data from the tracking data store 510. The user interface logic 530 may then display the data, rules that the decision guiding logic 520 applied in analyzing the data, and a set of recommendations associated with the data and the applied rules. Thus, the system 500 may be employed by an ATC team and/or other member of an organization to facilitate determining whether an ATC team should engage in a project. If the ATC team engaged in the project, then the system 500 can facilitate tracking the project and, when the project is closed, distributing information about the project. For example, a hardware/software integration issue may have arisen during the project. Data concerning the integration issue may be stored in the tracking data store 510. Recommendations concerning how to resolve the issue may have been provided by the decision guiding logic 520. The user interface logic 530 may then make available information about the issue and its resolution.

Thus, the tracking data store 510, embodied as a disk, a tape, a memory, a data structure, a file, a record, and the like, may serve as means for storing issue-resolution data associated with a pre-sales technical consulting project engaged in by an ATC team. The ATC team may have supported a customer-facing portion of an organization with which the ATC team is associated and, as part of the project, stored data about issues (e.g., hardware, software, integration errors) and how they were resolved. Similarly, the decision guiding logic 520, embodied in software, hardware, firmware, and/or a combination thereof, may serve as means for guiding an ATC team decision during a pre-sales technical consulting project. For example, the decision guiding logic 520 may reference the issue-resolution data previously stored to facilitate guiding a decision on a subsequent project.

The user interface logic 530 may be associated with a computer system (not illustrated) that has a graphical user interface comprising a display and a selection device. Thus, the user interface logic 530 may facilitate the graphical user interface performing a method for providing and selecting from a set of data entries on the display. The method may include retrieving a set of data entries (e.g., from the tracking data store 510 or elsewhere), where a data entry represents a piece of information associated with a pre-sales technical consulting project engaged in by an ATC team. The method may also include displaying (e.g., under user interface logic 530 control) a subset of the set of data entries on the display and receiving a data entry selection signal indicative of the selection device selecting a selected data entry. In response to the data entry selection signal, the method may include initiating a pre-sales technical consulting operation (e.g., identifying initiator, qualifying project, determining whether to engage) associated with the selected data entry. By way of illustration, a set of questions that facilitate pre-sales technical consulting actions like qualifying a project may be stored in the tracking data store 510. The decision guiding logic 520 may present questions to a user like an ATC team member via the graphical user interface as supported by the user interface logic 530. Thus, data entries like answer choices for the questions may be provided to the graphical user interface, a user may select a choice, and the answer may be stored in the tracking data store 510. Furthermore, based on the answer, a pre-sales technical consulting operation like determining whether a project qualifies for engagement by the ATC team may be undertaken.

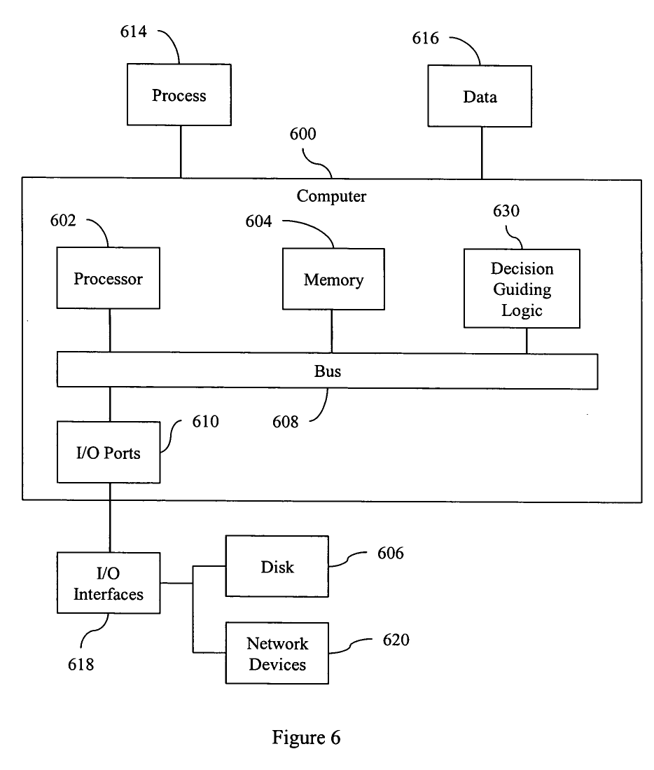

FIG. 6 illustrates a computer 600 that includes a processor 602, a memory 604, and input/output ports 610 operably connected by a bus 608. In one example, the computer 600 may include a decision guiding logic 630 configured to facilitate pre-sales technical consulting by an ATC team. While the decision guiding logic 630 is illustrated connected to the bus 608, it is to be appreciated that it can be arranged in different configurations in computer 600. The decision guiding logic 630 may facilitate performing computer executable portions of the example methods described herein. Similarly, the decision guiding logic 630 may perform functions like those described for the decision guiding logic 520. By way of illustration, when determining whether to engage in a pre-sales technical consulting project, an ATC team member may employ computer 600 to make certain determinations. For example, memory 604 may be configured to store project data, customer data, and ATC team data. Decision guiding logic 630 may be configured to access the memory 604, analyze the data stored therein, and applying rules, decision trees, heuristics, artificial intelligence, and so on, to compute a data point associated with the determination.

The processor 602 can be a variety of various processors including dual microprocessor and other multi-processor architectures. The memory 604 can include volatile memory and/or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 606 may be operably connected to the computer 600 via, for example, an input/output interface (e.g., card, device) 618 and an input/output port 610. The disk 606 can include, but is not limited to, devices like a magnetic disk drive, a solid state disk drive, a floppy disk drive, a tape drive, a Zip drive, a flash memory card, and/or a memory stick. Furthermore, the disk 606 can include optical drives like a CD-ROM, a CD recordable drive (CD-R drive), a CD rewriteable drive (CD-RW drive), and/or a digital video ROM drive (DVD ROM). The memory 604 can store processes 614 and/or data 616, for example. The disk 606 and/or memory 604 can store an operating system that controls and allocates resources of the computer 600.

The bus 608 can be a single internal bus interconnect architecture and/or other bus or mesh architectures. The bus 608 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 600 may interact with input/output devices via i/o interfaces 618 and input/output ports 610. Input/output devices can include, but are not limited to, a keyboard, a microphone, a pointing and selection device, cameras, video cards, displays, disk 606, network devices 620, and the like. The input/output ports 610 can include but are not limited to, serial ports, parallel ports, and USB ports.

The computer 600 can operate in a network environment and thus may be connected to network devices 620 via the i/o devices 618, and/or the i/o ports 610. Through the network devices 620, the computer 600 may interact with a network. Through the network, the computer 600 may be logically connected to remote computers. The networks with which the computer 600 may interact include, but are not limited to, a local area network (LAN), a wide area network (WAN), and other networks. The network devices 620 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and the like. Similarly, the network devices 620 can connect to WAN technologies including, but not limited to, point to point links, circuit switching networks like integrated services digital networks (ISDN), packet switching networks, and digital subscriber lines (DSL).

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicants' general inventive concept. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”, similar to the familiar A and/or B. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

1. A method by which an advanced technical consulting (ATC) team may support a customer-facing portion of an organization by selectively engaging in a pre-sales technical consulting project, the method comprising:
receiving a request to engage in a technical consulting project;
identifying an initiator of the request;
qualifying the technical consulting project;
identifying an organizational ownership of the technical consulting project;
scoping the technical consulting project;
determining whether to engage in the technical consulting project;
selectively working on the technical consulting project; and
closing the technical consulting project.

2. The method of claim 1, where the request is received by one or more of, a voice mail, a phone call, an email, a written request, an in-person communication, a communication received during a different customer opportunity, and a communication received during a different customer engagement.

3. The method of claim 1, where identifying the initiator includes identifying whether the initiator is a member of the organization.

4. The method of claim 1, where identifying the initiator includes identifying whether the initiator has an established contact with the organization.

5. The method of claim 4, including gathering an initiator relationship data concerning one or more of, an initiator relationship to a customer, an initiator relationship to the ATC team, and an initiator relationship to the organization.

6. The method of claim 1, where qualifying the technical consulting project includes determining one or more of, whether the technical consulting project is a pre-sales project, whether a customer has a support contract with the organization, whether the ATC team is interested in solving a problem associated with the technical consulting project, whether the ATC team is qualified to solve the problem associated with the technical consulting project, whether the ATC team has a resource available to engage in the technical consulting project, and whether the technical consulting project is aligned with a goal of one or more of, the ATC team, and the organization.

7. The method of claim 1, where identifying the organizational ownership of the technical consulting project comprises:
acquiring a customer data that facilitates characterizing a customer;
acquiring a project data that facilitates characterizing the technical consulting project; and
analyzing the customer data, the project data, the request to engage in the technical consulting project, and a relationship between the initiator and one or more of, the customer, the ATC team, and the organization, to determine who is responsible for the customer.

8. The method of claim 7, where the customer data includes one or more of, a name data, an accounts receivable data, a bill paying history data, a location data, and an expertise data.

9. The method of claim 7, where the project data includes one or more of, a name data, a time estimate data, a cost estimate data, an account number, a technical consultant data, and a projected return on investment data.

10. The method of claim 1, where scoping the technical consulting project includes acquiring a scope data that concerns one or more of, a customer problem, a customer suggestion, a customer need, a business problem to be solved for a customer, a customer history with the organization, a customer history with the ATC team, a revenue associated with the technical consulting project, a cost associated with the technical consulting project, a return on investment associated with the technical consulting project, a customer expertise level, a customer architecture, a measure of success for the technical consulting project, and an expected outcome of the technical consulting project.

11. The method of claim 1, where determining whether to engage in the technical consulting project includes determining one or more of, whether the technical consulting project is a pre-sales technical consulting activity, whether the technical consulting project is appropriate for the ATC team, and whether the technical consulting project will result in a positive return on investment for the organization.

12. The method of claim 10, where determining whether to engage in the technical consulting project includes determining one or more of, whether the technical consulting project is a pre-sales technical consulting activity, whether the technical consulting project is appropriate for the ATC team, and analyzing the scope data.

13. The method of claim 7, where determining whether to engage in the technical consulting project includes analyzing the customer data and the project data to determine whether the technical consulting project is a pre-sales technical consulting activity that is appropriate for the ATC team.

14. The method of claim 1, where selectively working on the technical consulting project includes one or more of, identifying a criteria for determining a success of the technical consulting project, developing a solution that satisfies the criteria, where the solution is based, at least in part, on one or more of, a customer data, a project data, and a scope data, communicating the solution to the customer-facing portion of the organization, and selectively providing a project tracking data to a project tracking data store.

15. The method of claim 14, where the customer data includes one or more of, a name data, an accounts receivable data, a bill paying history data, a location data, and an expertise data.

16. The method of claim 14, where the project data includes one or more of, a name data, a time estimate data, a cost estimate data, an account number, a technical consultant data, and a projected return on investment data.

17. The method of claim 14, where the scope data includes one or more of, a customer problem data, a customer suggestion data, a customer need data, a business problem to be solved for a customer, a customer history with the organization, a customer history with the ATC team, a revenue associated with the technical consulting project, a cost associated with the technical consulting project, a return on investment associated with the technical consulting project, a customer expertise level, a customer architecture, a measure of success for the technical consulting project, and an expected outcome of the technical consulting project.

18. The method of claim 1, where closing the technical consulting project comprises:
acquiring an agreement from one or more of, a customer, the initiator, and an organizational owner that the technical consulting project is complete; and
selectively making available a project experience data based, at least in part, on a project tracking data that facilitates characterizing the project.

19. The method of claim 18, where the project experience data includes one or more of, a best practices data that identifies a best business practice associated with the technical consulting project, a software error data that identifies a software error associated with the technical consulting project, a hardware error data that identifies a hardware error associated with the technical consulting project, an integration error data that identifies an integration error associated with the technical consulting project, a customer experience data that facilitates characterizing the customer as experienced during the technical consulting project, a software error resolution data, a hardware error resolution data, and an integration error resolution data.

20. A method, comprising:
an ATC team receiving a request to engage in a technical consulting project, where the ATC team is a part of an organization that includes a customer-facing part;
identifying a person who generated the request;
qualifying the technical consulting project to facilitate determining whether the technical consulting project is a type of project in which the ATC team engages;
the ATC team scoping the technical consulting project;
determining whether to engage in the technical consulting project;
the ATC team selectively working the technical consulting project; and
the ATC team closing the technical consulting project.

21. The method of claim 20, where identifying the person who generated the request includes identifying a relationship between the person who generated the request and one or more of, the ATC team, the technical consulting project, the organization, and the customer-facing part of the organization.

22. The method of claim 21, where qualifying the technical consulting project includes determining one or more of, whether the technical consulting project is a pre-sales project that concerns a problem that the ATC team is capable of solving, whether the technical consulting project is a pre-sales project that concerns a problem that the ATC team is interested in solving, and whether the technical consulting project has a measurable outcome.

23. The method of claim 22, where scoping the technical consulting project includes one or more of, determining an objective for the technical consulting project, determining an actual cost for the technical consulting project, determining an opportunity cost for the technical consulting project, and determining one or more technical parameters concerning work to be performed during the technical consulting project.

24. The method of claim 23, where determining whether to engage in the technical consulting project includes evaluating one or more of, the objective, the actual cost, the opportunity cost, and the technical parameters.

25. The method of claim 24, where selectively working the technical consulting project includes one or more of, developing software, developing hardware, debugging software, debugging hardware, integrating software with software, integrating hardware with hardware, and integrating hardware with software.

26. The method of claim 25, where closing the technical consulting project includes storing an experience data that describes one or more of, a lesson learned during the technical consulting project, a best practice associated with the technical consulting project, a software error associated with the technical consulting project, a hardware error associated with the technical consulting project, an integration error associated with the technical consulting project, a software error resolution data, a hardware error resolution data, and an integration error resolution data.

27. A system, comprising:
a tracking data store configured to store data concerning an ATC team pre-sales technical consulting engagement;
a decision guiding logic operably connected to the tracking data store, the decision guiding logic configured to facilitate guiding one or more decisions during the pre-sales technical consulting engagement, where the one or more decisions depend, at least in part, on the data stored in the tracking data store; and
a user interface logic operably connected to the tracking data store and the decision guiding logic, the user interface logic being configured to facilitate displaying one or more data items stored in the tracking data store and one or more decision guiding data provided by the decision guiding logic.

28. The system of claim 27, where the tracking data store is configured to store one or more of, an engagement data that facilitates characterizing the consulting engagement, a customer data that facilitates characterizing a customer, an ATC team data that facilitates characterizing the ATC team, a best practice data that facilitates characterizing a best practice associated with the consulting engagement, a software error data that facilitates characterizing a software error associated with the consulting engagement, a hardware error data that facilitates characterizing a hardware error associated with the consulting engagement, an integration error data that facilitates characterizing an integration error observed during the consulting engagement, and a resolution data that facilitates characterizing an error resolution.

29. A system, comprising:
means for storing issue-resolution data associated with a pre-sales technical consulting project engaged in by an ATC team, where the ATC team supports a customer-facing portion of an organization with which the ATC team is associated by engaging in the pre-sales technical consulting project; and
means for guiding an ATC team decision during the pre-sales technical consulting project.

30. In a computer system having a graphical user interface comprising a display and a selection device, a method of providing and selecting from a set of data entries on the display, the method comprising:
retrieving a set of data entries, where a data entry represents a piece of information associated with a pre-sales technical consulting project engaged in by an ATC team;
displaying a subset of the set of data entries on the display;
receiving a data entry selection signal indicative of the selection device selecting a selected data entry; and
in response to the data entry selection signal, initiating a pre-sales technical consulting operation associated with the selected data entry.

31. A method, comprising:
acquiring a first data that facilitates characterizing an advanced technical consulting team;
acquiring a second data that facilitates characterizing a pre-sales technical consulting project;
determining whether to allocate the advanced technical consulting team to the pre-sales technical consulting project based, at least in part, on the first data and the second data; and
if the advanced technical consulting team is allocated to the pre-sales technical consulting project:
selectively acquiring a third data that facilitates characterizing the pre-sales technical consulting project, where the third data is gathered during the pre-sales technical consulting project;
selectively storing the third data; and
selectively making the third data available outside the advanced technical consulting team.

32. A computer-readable medium having stored thereon a data structure comprising:
a first field containing data associated with an ATC team pre-sales technical consulting engagement request;
a second field containing data associated with an ATC team pre-sales technical consulting engagement requester;
a third field containing data associated with one or more parameters of a pre-sales technical consulting engagement;
a fourth field containing data gathered during the pre-sales technical consulting engagement; and
a fifth field containing a distribution data derived from one or more of, data located in the first field, data located in the second field, data located in the third field, and data located in the fourth field, where the distribution data is available to one or more members of an organization with which the ATC team is associated.

33. A computer-readable medium having stored thereon a data structure comprising one or more fields containing one or more of, a data associated with an ATC team pre-sales technical consulting engagement request, a data associated with an ATC team pre-sales technical consulting engagement requester, a data associated with one or more parameters of a pre-sales technical consulting engagement, a data gathered during the pre-sales technical consulting engagement, and a distribution data derived from one or more of, the data associated with an ATC team pre-sales technical consulting engagement request, the data associated with an ATC team pre-sales technical consulting engagement requester, the data associated with one or more parameters of a pre-sales technical consulting engagement, and the data gathered during the pre-sales technical consulting engagement.
